(19) United States
(12) Patent Application Publication
(10) Pub. No.: US 2010/0294303 A1
(43) Pub. Date: Nov. 25, 2010

(54) TOOTHPICK

(76) Inventor: Sung-Chul Son, Paju (KR)

Correspondence Address: ROBERT E. BUSHNELL & LAW FIRM, 2029 K STREET NW, SUITE 600, WASHINGTON, DC, 20006-1004, US

(21) Appl. No.: 12/812,622

(22) PCT Filed: Oct. 1, 2008
(86) PCT No.: PCT/KR2008/005758

§ 371 Date: Jul. 13, 2010

(30) Foreign Application Priority Data
May 27, 2008 (KR) 20-2008-0006866

(51) Int. Cl. A61C 15/02

(52) U.S. Cl. 132/329

(57) ABSTRACT

A toothpick is disclosed, in which a thinner tooth picking part is formed in one end for an insertion into between teeth with the thinner tooth picking part being thicker than that of a body of a toothpick, and a thicker tooth picking part having an engaging discharge part is formed in the other end having the same thickness as the body of a toothpick, so a tooth gum is not hurt during a picking of a toothpick, and it is possible to effectively remove a piece of food stuck between teeth.

### CLAIM OF PRIORITY

This application makes reference to, incorporates the same herein, and claims all benefits accruing under 35 U.S.C. §365(c) of my PCT International application entitled TOOTHPICK filed on 1 Oct. 2008 and duly assigned Serial No. PCT/KR2008/005758.

### BACKGROUND OF THE INVENTION

1. Field of the Invention

The present invention relates to a toothpick, and in particular to a toothpick in which a thinner tooth picking part is formed in one end for an insertion into between teeth with the thinner tooth picking part being thicker than that of a body of a toothpick, and a thicker tooth picking part having an engaging discharge part is formed in the other end having the same thickness as the body of a toothpick, so a tooth gum is not hurt during a picking of a toothpick, and it is possible to effectively remove a piece of food stuck between teeth.

2. Description of the Related Art

Generally, a toothpick is designed to effectively remove a piece of food stuck between teeth after a user eats food.

As shown in FIG. 3, a toothpick 200 is equipped with a rod shaped body having a length of 5˜8 cm by using a wood, and a sharp tooth picking part 210 formed at both ends of a body of a toothpick. The thickness of a body is generally 1.5˜3 mm.

The conventional toothpick 200 is equipped with a tooth picking part 210 having an apex part formed at both ends, and its intermediate portion has the same thickness of a body and is short. When using the conventional toothpick, a thicker body part might be inserted into between teeth, so a tooth gum might be hurt, and the space between neighboring teeth might be widened, which leads to causing a lot of inconveniences.

In order to overcome the above problems of the conventional toothpick 200, as shown in FIG. 4, the Japanese patent publication Hei 10-5250 discloses a toothpick 200 that a tooth picking part 210 is made thinner, and a plurality of protrusions are formed along its side surface.

However, the toothpick 200 of the Japanese patent publication Hei 10-5250 is equipped with a tooth picking part 210 formed in a flat shape, not a rod shape, and has the same thickness as the thickness of the body of the conventional toothpick 200, so when using the above toothpick, a user's tooth gum might be hurt.

Since the tooth picking part 210 is integrally formed of an engaging part, a tooth picking work between neighboring teeth is not easy, and the tooth picking part might be easily bent when removing a piece of food stuck between relatively distanced teeth, so it is not easy to use the above conventional toothpick.

### SUMMARY OF THE INVENTION

Accordingly, it is an object of the present invention to provide an improved toothpick which overcomes the problems that an end of a conventional toothpick is simply sharp, so a user's tooth gum might be hurt due to a relatively thick thickness of a body of a toothpick, and a distance of neighboring teeth might be widened and that a tooth picking part is flat and has a certain width, so a user's tooth gum might be hurt when using a conventional toothpick, and it is impossible to use a conventional toothpick for a tooth which has a relatively large space between neighboring teeth.

A toothpick according to the present invention comprises a thin tooth picking part at one side which is thinner than that of a body of a toothpick and is longer, so that a toothpick can be easily inserted into between teeth, and an engaging discharge part having the same thickness as a body of its opposite.

In the present invention, since a thinner and longer tooth picking part is formed in one side of a toothpick, a user's tooth gum is not hurt when picking a tooth. Furthermore, since a tooth picking part is thinner and longer, it can be substantially inserted into between teeth for easily removing a piece of food stuck between teeth. A thicker tooth picking pat having an engaging discharge part is formed in an opposite of a thinner tooth picking part.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a perspective view illustrating a toothpick according to an embodiment of the present invention.

FIG. 2 is a perspective view illustrating a toothpick according to another embodiment of the present invention.

FIG. 3 is a perspective view illustrating a conventional toothpick.

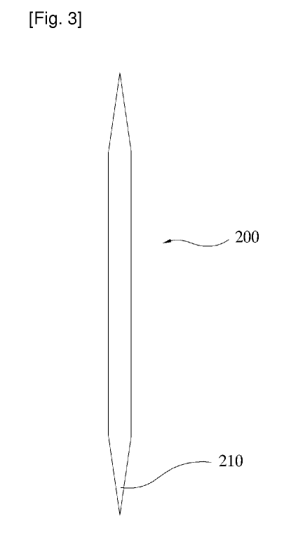

FIG. 4 is a perspective view of another example of a conventional toothpick.

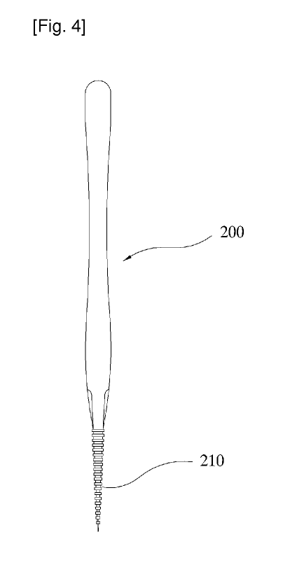

### DETAILED DESCRIPTION OF THE INVENTION

The present invention relates to a toothpick comprising a thinner tooth picking part 120 which is formed in one side of a body 110 and is thinner and longer than the body 110 for thereby being easily inserted into between teeth; and a thicker tooth picking part 130 which is formed in the opposite side of the same and has the same thickness as the body 110 and has an engaging discharge part 131, wherein the thinner tooth picking part 120 has a thickness of 0.5˜1 mm thinner than the thickness of the body 10 having a thickness of 1.5˜3 mm and has a thinner rod part having a length of 25˜60% of the total length of a toothpick having a length of 5˜8 cm, and a thinner apex part 122 which is formed in an end of the thinner rod part and is sharpened for an easier insertion into between teeth, and wherein the thicker tooth picking pat 130 has an engaging discharge part 131 having an engaging shoulder in its outer surface in an inner direction of the end for easily removing a piece of food stuck between teeth as a space between teeth is wider, and a thicker apex part 132 which is sharpened toward the end from the engaging discharge part 131.

The preferred embodiments of the present invention will be described with reference to the accompanying drawings.

The present invention is basically directed to preventing any damages to a user's tooth gum during a use of a toothpick while preventing a widening between teeth.

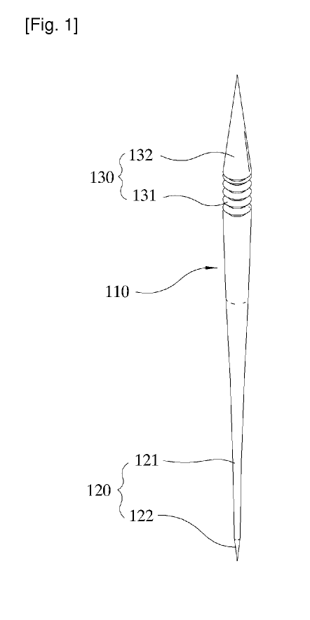

As shown in FIG. 1, the present invention comprises a thinner tooth picking part 120 which is formed in one end of a body 110 and is thinner than the thickness of that of the body 110 and is substantially longer, and a thicker tooth picking part 130 which is formed in the other end of the body and has the same thickness as the body 110 and has an engaging discharge part 131.

Here, the thinner tooth pocking part 120 has a thickness of 0.5˜1 mm thinner than the body 110 having 1.5˜3 mm, and is formed of a thinner rod shaped part 131 having 25˜60% of the whole length of a tooth pick generally having a length of 5˜8 cm, and a thinner apex part 122 which is formed in an end of the thinner rod shaped part 121 and is substantially thinner for an easier insertion into between teeth.

The thicker tooth picking part 130 is equipped with an engaging discharge part 131 having an engaging shoulder in an outer surface in an inner direction of the end for removing a piece of food such as meat or fiber food since the distance between teeth is wider, and a thicker apex part 132 is formed toward the end from the engaging discharge part 131.

It is preferred that the toothpick is made of a white birch having flexibility with respect to the absorption of moisture, so that the flexibility of the toothpick increases with the help of moisture contained in saliva when using the toothpick.

In addition, it is preferred that the engaging discharge part 131 of the thicker tooth picking part 130 is equipped with a spiral engaging shoulder.

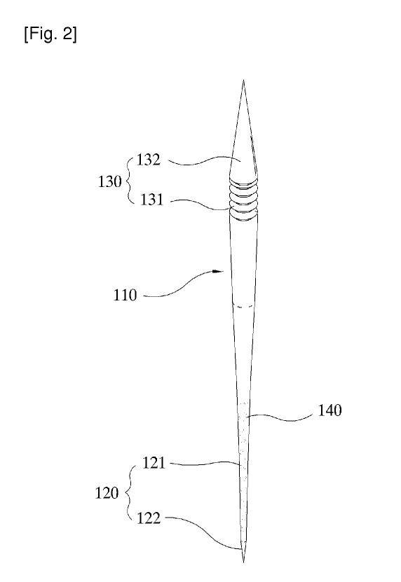

As shown in FIG. 2, a mouth bad smell removing part 140 impregnated or coated with a certain mouth bad smell removing agent such as a peppermint might be provided in the thinner tooth picking part 120.

The manufacturing and use of the present invention will be described.

In the present invention, there is provided a toothpick which comprises a thinner tooth picking part 120 which is formed in one side of a body 110 and is thinner and longer than the body 110 for thereby being easily inserted into between teeth; and a thicker tooth picking part 130 which is formed in the opposite side of the same and has the same thickness as the body 110 and has an engaging discharge part 131, wherein the thinner tooth picking part 120 has a thickness of 0.5˜1 mm thinner than the thickness of the body 10 having a thickness of 1.5˜3 mm and has a thinner rod part having a length of 25˜60% of the total length of a toothpick having a length of 5˜8 cm, and a thinner apex part 122 which is formed in an end of the thinner rod part and is sharpened for an easier insertion into between teeth, and wherein the thicker tooth picking pat 130 has an engaging discharge part 131 having an engaging shoulder in its outer surface in an inner direction of the end for easily removing a piece of food stuck between teeth as a space between teeth is wider, and a thicker apex part 132 which is sharpened toward the end from the engaging discharge part 131.

In the present invention, when a toothpick is manufactured by using a wood, a rod shaped body 110 having a thickness of 1.5˜3 mm is made.

A thinner rod part 121 having a thickness of 0.5˜1 mm thinner than the thickness of the body and a length of about 3 cm is formed in one side of the body 110, and a thinner tooth pocking part 120 having a thinner apex part 122 is formed in its end.

A thicker apex part 132 made by sharpening its end is formed in the opposite side of the thinner tooth picking part 120, and an engaging discharge part 30 having an engaging shoulder is formed in an inner outer surface of the thicker apex part 132 for thereby manufacturing a thicker tooth pocking part 130, so the manufacturing of the toothpick according to the present invention is finished.

When using the toothpick according to the present invention, a user holds a body 110 and inserts a thinner tooth picking part 120 into between teeth, and the thinner tooth picking part 120 absorbs saliva residing between teeth based on osmotic pressure and becomes soft and flexible for a smooth insertion of the toothpick, and then removes a piece between teeth.

When a lot of food is stuck between teeth, the thicker tooth picking part 130 having an engaging discharge part 131 is inserted between teeth and is rotated for thereby winding the food between teeth, so it is possible to effectively remove pieces of food stuck between teeth without hurting a tooth gum.

In addition, when using the present invention, a tooth gum ointment might be coated on the thinner tooth picking part 120 for thereby applying the ointment to a gum between teeth, which leads to enhancing the health of teeth.

When using the present invention, a mouth bad smell removing part might be impregnated or coated in the thinner tooth picking part 120 for thereby concurrently removing a piece of food stuck between teeth and a mouth bad smell.

As described above, the toothpick according to the present invention comprises a thinner and longer tooth picking part in its one end for thereby preventing a tooth gum from being hurt when using the toothpick.

Since a thinner tooth picking part is substantially thinner and longer, it can be reliably inserted into between teeth, so it is possible to efficiently remove a piece between teeth.

In addition, a thicker tooth picking part having an engaging discharge part is formed in the opposite side of the thinner tooth picking part, so it is possible to effectively remove a piece of food stuck in a relatively wider space between teeth.

1. A toothpick, comprising:
a thinner tooth picking part which is formed in one side of a body and is thinner and longer than the body for thereby being easily inserted into between teeth; and
a thicker tooth picking part which is formed in the opposite side of the same and has the same thickness as the body and has an engaging discharge part;
wherein said thinner tooth picking part has a thickness of 0.5˜1 mm thinner than the thickness of the body 10 having a thickness of 1.5˜3 mm and has a thinner rod part having a length of 25˜60% of the total length of a toothpick having a length of 5˜8 cm, and a thinner apex part 122 which is formed in an end of the thinner rod part and is sharpened for an easier insertion into between teeth; and
wherein said thicker tooth picking pat has an engaging discharge part having an engaging shoulder in its outer surface in an inner direction of the end for easily removing a piece of food stuck between teeth as a space between teeth is wider, and a thicker apex part which is sharpened toward the end from the engaging discharge part.

2. The toothpick of claim 1, wherein said toothpick is made of white birch which has a certain flexibility enhanced by means of moisture contained in saliva during the use of the toothpick, and a mouth bad smell removing part having a mouth bad smell removing agent is formed in the thinner tooth picking part.
